(19) United States
(12) Patent Application Publication
(10) Pub. No.: US 2024/0092478 A1
(43) Pub. Date: Mar. 21, 2024

(54) AIRCRAFT COMPRISING AT LEAST ONE ENERGY RECEIVING ELEMENT AND AT LEAST ONE ELECTRIC DRIVE SYSTEM POWERED BY THE ENERGY RECEIVING ELEMENT AND CONFIGURED TO MOVE THE AIRCRAFT ON THE GROUND

(71) Applicant: Airbus SAS, BLAGNAC (FR)

(72) Inventors: Didier CHASSAIGNE, BLAGNAC (FR); Olivier CREPEL, BLAGNAC (FR)

(21) Appl. No.: 18/460,858

(22) Filed: Sep. 5, 2023

(30) Foreign Application Priority Data
Sep. 15, 2022 (FR) 2209265

(51) Int. Cl. B64C 25/32; B60L 5/38

(52) U.S. Cl. CPC B64C 25/405; B60L 5/38; B60L 2200/10

(57) ABSTRACT

An aircraft comprising at least one electric drive system configured to drive a wheel of a landing gear in rotation and at least one energy receiving element configured to power the electric drive system and cooperate with an energy emitting element present on the ground, the energy receiving and emitting elements forming an electrical energy transfer device allowing, when the aircraft is moving on the ground, a transfer of electrical energy from the energy emitting element to the energy receiving element.

### CROSS-REFERENCES TO RELATED APPLICATIONS

This application claims the benefit of French Patent Application Number 2209265 filed on Sep. 15, 2022, the entire disclosure of which is incorporated herein by way of reference.

### FIELD OF THE INVENTION

The present application relates to an aircraft comprising at least one energy receiving element and at least one electric drive system powered by the energy receiving element and configured to move the aircraft on the ground.

### BACKGROUND OF THE INVENTION

Before an aircraft takes off or after it lands, the aircraft moves on the ground by taxiing on a taxiway of an airport facility between a parking zone and the takeoff and landing runway. In order to move on the ground, the aircraft uses the thrust generated by its propulsion assemblies and/or by its auxiliary power unit (APU).

This solution is not optimal since the aircraft consumes energy in the form of fuel stored in its tanks in order to move on the ground, and this leads to an increase in the fuel consumption and the on-board mass of the aircraft.

The present invention aims to remedy all or some of the drawbacks of the prior art.

### SUMMARY OF THE INVENTION

To this end, the invention relates to an aircraft comprising at least one landing gear having at least one wheel configured to roll on the ground when the aircraft is moving on the ground.

According to the invention, the aircraft comprises at least one electric drive system configured to drive the wheel in rotation and at least one energy receiving element configured to power the electric drive system and cooperate with an energy emitting element present on the ground, the energy receiving and emitting elements forming an electrical energy transfer device allowing, when the aircraft is moving on the ground, a transfer of electrical energy from the energy emitting element to the energy receiving element.

According to the invention, the energy receiving element comprises at least one caster configured to roll on the ground and keep it at a given distance from the ground.

This solution makes it possible to reduce the on-board mass and the fuel consumption of the aircraft since the latter no longer consumes fuel in order to move on the ground. Furthermore, the caster of the energy receiving element makes it possible to maintain a fixed distance between the energy receiving element and the energy emitting element on the ground, and therefore to maintain a constant gap between the energy receiving and emitting elements.

According to another feature, the energy receiving element is an electromagnetic induction element configured to generate an electric current when it is positioned in a magnetic field generated by the energy emitting element.

According to another feature, the energy receiving element is separate from the wheel.

According to another feature, the aircraft comprises at least one deployment system configured to move the energy receiving element between a deployed position in which the energy receiving element cooperates with the energy emitting element and a retracted position in which the energy receiving element does not generate aerodynamic disturbances when the aircraft is in flight.

According to another feature, the deployment system has a pylon having a first end connected by an articulation to a part of the aircraft that is able to move between deployed and retracted positions and a second end connected to the energy receiving element and at least one actuator configured to move the energy receiving element between first and second positions.

According to another feature, the energy receiving element is as one with a part of the aircraft, said aircraft part being able to move between deployed and retracted positions, the energy receiving element being fixed with respect to this mobile part of the aircraft.

According to another feature, the electric drive system is positioned at the landing gear and separate from the wheel, the landing gear comprising a coupling system connecting the wheel and the electric drive system.

According to another feature, the electric drive system is integrated in the wheel in the manner of a wheel motor.

### BRIEF DESCRIPTION OF THE DRAWINGS

Further features and advantages will become apparent from the following description of the invention, which description is given solely by way of example, with reference to the appended drawings in which:

FIG. 1 is a side view of an aircraft equipped with an energy receiving element, illustrating one embodiment of the invention,

FIG. 2 is a top view of a part of an airport facility equipped with energy emitting elements, illustrating one embodiment of the invention,

FIG. 3 is a schematic depiction from the side of a part of a landing gear of an aircraft comprising an energy receiving element of the contactless type, illustrating one embodiment of the invention,

FIG. 4 is a schematic depiction from the side of a part of a landing gear of an aircraft comprising an energy receiving element of the contact-based type, illustrating one embodiment of the invention,

FIG. 5 is a perspective view of a part of a landing gear of an aircraft comprising an electric drive system and an energy receiving element, illustrating one embodiment of the invention,

FIG. 6 is a schematic depiction from the side of a part of a landing gear, illustrating one embodiment of the invention,

FIG. 7 is a schematic depiction from the side of a part of a landing gear, illustrating another embodiment of the invention,

FIG. 8 is a schematic depiction from the side of a part of a landing gear, illustrating another embodiment of the invention, and

FIG. 9 is a schematic depiction from the side of a part of a landing gear, illustrating another embodiment of the invention.

### DETAILED DESCRIPTION OF THE PREFERRED EMBODIMENTS

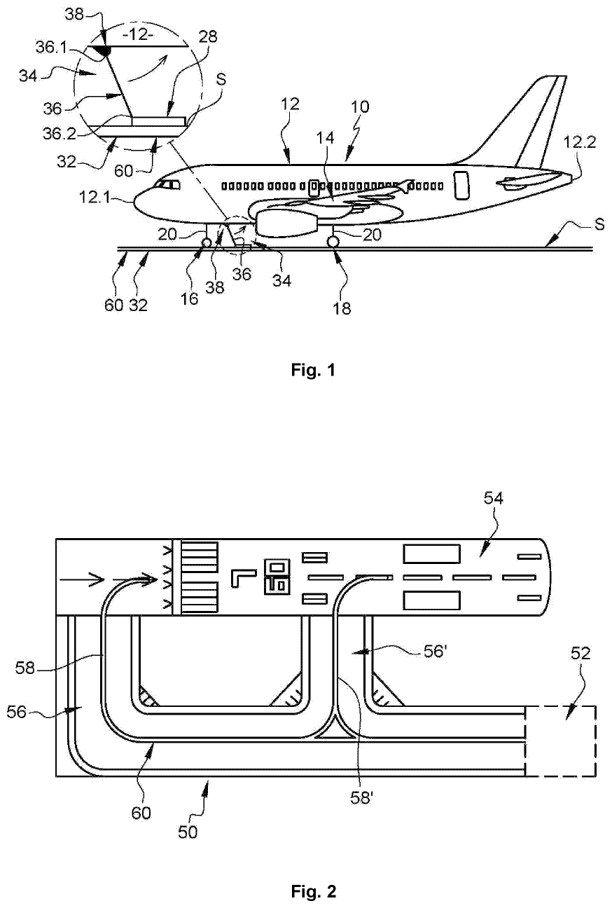

According to an embodiment visible in FIG. 1, an aircraft 10 comprises a fuselage 12 that extends between a nose 12.1 and a tail 12.2, wings 14 connected to the fuselage 12, a front landing gear 16 connected to the fuselage 12 and positioned at or near the nose 12.1 and two main landing gears 18 connected to the fuselage 12 or to the wings 14.

Each front or main landing gear 16, 18 is able to move between a deployed position, as illustrated in FIG. 1, and a position in which it is retracted into a landing gear bay (not shown).

The front or main landing gears 16, 18 are in the deployed position when the aircraft 10 is moving on the ground S and in the retracted position when the aircraft is in flight, in particular in the cruising phase.

According to one embodiment, a front or main landing gear 16, 18 comprises a strut 20 having a first end connected by an articulation to the fuselage and a second end, at least one wheel support 22 connected to the second end of the strut 20 and substantially perpendicular to the strut 20, at least one wheel 24 mounted so as to be able to pivot on the wheel support 22 and an actuator (not shown) configured to make the strut 20 pivot between the deployed and retracted positions. According to one configuration, the front or main landing gear 16, 18 comprises two wheel supports 22, 22′ that extend on either side of the strut 20 and two wheels 24, 24′ (one being shown in dashed line) positioned on either side of the strut 20.

Each wheel 24, 24′ comprises a rim 24.1 mounted on the wheel support 22 and a tire 24.2 mounted on the rim 24.1 and having a tread 24.3 in contact with the ground S when the aircraft 10 is moving on the ground S.

The front or main landing gear 16, 18 is not described in greater detail since it may be identical to those of the prior art. Whatever the embodiment, the aircraft comprises at least one landing gear 16, 18 comprising at least one wheel 24, 24′, the landing gear being configured to occupy a deployed position in which the wheel 24, 24′ is in contact with the ground S and rolls on the ground S when the aircraft is moving on the ground S and a retracted position in which the wheel 24, 24′ is not in contact with the ground S.

The aircraft 10 comprises at least one electric drive system 26 for driving at least one wheel 24 of at least one landing gear 16, 18 in rotation.

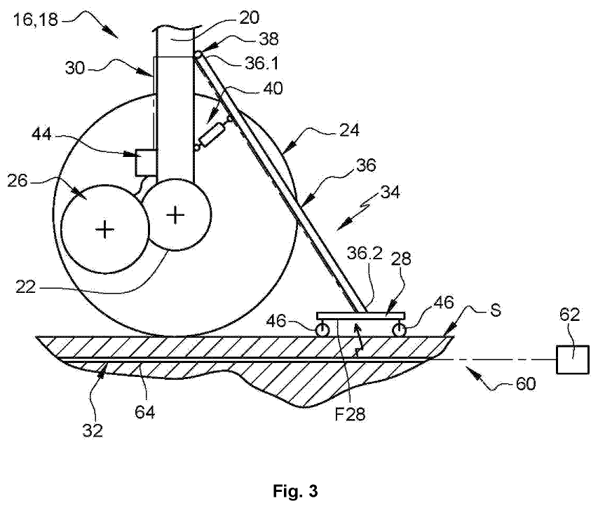

According to an arrangement visible in FIGS. 3 to 8, the electric drive system 26 is positioned at the landing gear 16, 18, near the second end of the strut 20, more particularly between the two wheels 24, 24′. According to this arrangement, the electric drive system 26 is separate from the wheel 24, 24′ and the landing gear 16, 18 comprises a coupling system connecting the wheel 24, 24′ and the electric drive system 26.

According to another arrangement, visible in FIG. 9, the electric drive system 26 is integrated in one of the wheels 24, 24′ of the landing gear 16, 18 in the manner of a wheel motor.

According to one embodiment, the aircraft 10 comprises a single electric drive system 26 coupled to one or more wheels 24, 24′ or integrated in a wheel 24, 24′. As a variant, the aircraft 10 comprises a plurality of electric drive systems 26 each coupled to one or more wheels 24, 24′ or integrated in a wheel 24, 24′. The electric drive system 26 can be installed equally at the front landing gear 16 or at one of the main landing gears 18.

According to one feature, the aircraft 10 comprises at least one energy receiving element 28 connected to at least one electric drive system 26 by an electrical connection 30 and configured to cooperate with an energy emitting element 32 present on the ground S, the energy receiving and emitting elements 28, 32 forming an electrical energy transfer device allowing, when the aircraft is moving on the ground S, a transfer of electrical energy from the energy emitting element 32 to the energy receiving element 28. Thus, the energy receiving element 28 is configured to supply the one or more electric drive systems 26 with electrical energy and capture the electrical energy present on the ground S during a movement of the aircraft on the ground S.

According to one embodiment, the energy receiving element 28 is configured to occupy a first, deployed position in which it cooperates with the energy emitting element 32 and a second, retracted position in which it is positioned inside the fuselage 12 or the wings 14 and does not generate aerodynamic disturbances when the aircraft is in flight. The energy receiving element 28 is considered to cooperate with the energy emitting element 32 when a transfer of electrical energy is possible between the energy receiving and emitting elements 28, 32.

According to a first embodiment, visible in FIG. 1, the aircraft 10 comprises at least one deployment system 34 that has a pylon 36 having a first end 36.1 connected by an articulation 38 to the fuselage 12 or to one of the wings 14 and a second end 36.2 connected to an energy receiving element 28 and at least one actuator configured to move the energy receiving element 28 between the first and second positions.

According to another embodiment, visible in FIG. 7, the energy receiving element 28 is as one with a part of the aircraft 10 that is able to move between deployed and retracted positions, such as the front landing gear 16 or main landing gear 18 and fixed with respect to this mobile part of the aircraft.

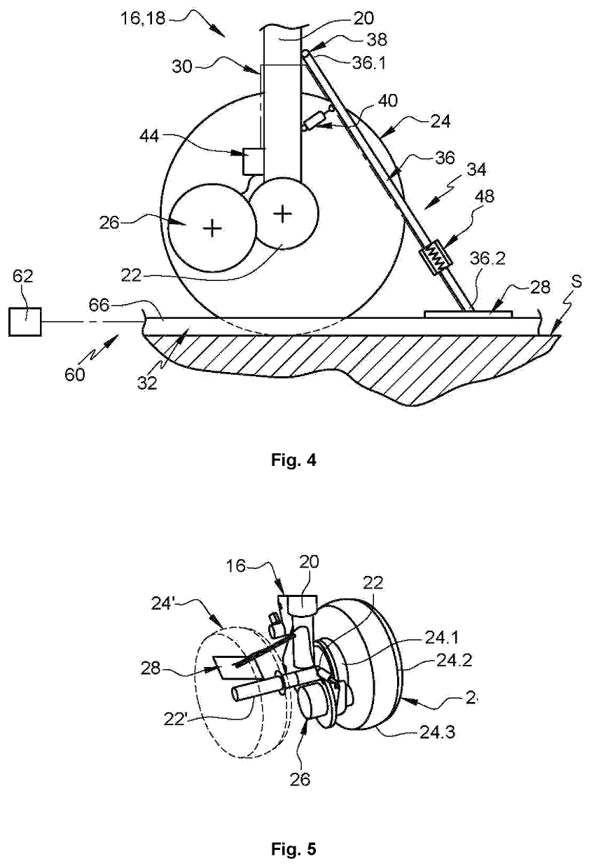

According to another embodiment, visible in FIGS. 3 and 4, the aircraft 10 comprises a deployment system 34 that has a pylon 36 having a first end 36.1 connected by an articulation 38 to a part of the aircraft 10 that is able to move between deployed and retracted positions, such as the front landing gear 16 or main landing gear 18, and a second end 36.2 connected to the energy receiving element 28. The deployment system 34 also comprises at least one actuator 40 configured to move the energy receiving element 28 between first and second positions.

Whatever these various embodiments, the aircraft 10 comprises at least one deployment system 34 configured to move the energy receiving element 28 between first and second positions. Depending on the circumstances, the deployment system 34 may be dedicated to the energy receiving element 28 or to another part of the aircraft, such as a landing gear, to which the energy receiving element 28 is connected or may be dedicated to the energy receiving element 28 and associated with another deployment system of another part of the aircraft that is able to move between deployed and retracted positions, such as a landing gear for example.

According to an embodiment visible in FIGS. 3 and 4, the aircraft 10 comprises an electrical energy processing system 44, such as an inverter, between the energy receiving element 28 and the electric drive system 26. The aircraft 10 may also comprise at least one electrical energy storage system, such as a battery, between the energy receiving element 28 and the electric drive system 26.

According to embodiments visible in FIGS. 3 and 5 to 9, the electrical energy transfer device is of the contactless type. According to an inductive technology, the energy emitting element 32 present on the ground S is configured to generate an electromagnetic field and the energy receiving element 28 is an electromagnetic induction element configured to generate an electric current when it is positioned in the magnetic field generated by the energy emitting element 32. In this case, the energy receiving element 28 comprises at least one coil.

According to one embodiment, the energy receiving element 28 is separate from the wheel 24, 24′ and comprises at least one active surface F28 facing the ground S when the energy receiving element 28 is in the first, deployed position, the one or more coils of the energy receiving element 28 being positioned near the active surface F28. The number and arrangement of the coils of the energy receiving element 28 are determined such that the coils cover a zone substantially equal to the active surface F28.

By way of example, for an electrical power of the order of 90 kW and a gap of the order of 20 mm, the active surface F28 has a surface area of the order of 10 to 15 dm², and this corresponds approximately to a square with a side length of 35 cm. In terms of geometry, the receiving element 28 has the shape of a plate that is approximately 2 cm in thickness (dimension measured perpendicular to the active surface F28).

According to one configuration, the energy receiving element 28 comprises at least one caster 46 configured to roll on the ground S when the energy receiving element 28 is in the first, deployed position and keep it at a given distance from the ground S in order to maintain a constant gap between the energy receiving and emitting elements 28, 32.

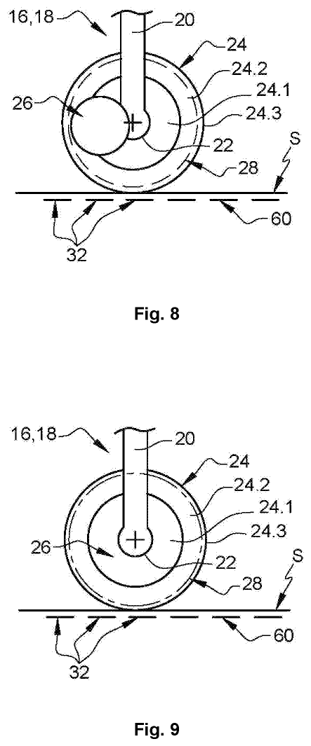

According to other embodiments, visible in FIGS. 8 and 9, the aircraft comprises a plurality of energy receiving elements 28 integrated in the wheel 24, 24′, more particularly in the tread 24.3 of the tyre 24.2 of the wheel 24, 24′ and distributed over the circumference of the wheel 24, 24′. According to these embodiments, the energy receiving elements 28 are in the form of plates distributed over the entire circumference of the tread 24.3, more particularly between the layers of the tread 24.3.

According to another embodiment, visible in FIG. 4, the electrical energy transfer device is of the contact-based type. According to one configuration, the energy receiving element 28 is a pad, separate from the wheel 24, 24′, able to move between deployed and retracted positions, configured to be in contact with the energy emitting element 32 in the deployed position.

According to another configuration, the energy receiving element 28 is a pad integrated in one of the wheels 24, 24′ of a landing gear 16, 18, which extends over the entire circumference thereof at its tread 24.3.

According to one configuration, the aircraft comprises a return element 48 for keeping the energy receiving element 28 in contact with the energy emitting element 32 at a substantially constant contact pressure.

As illustrated in FIG. 2, an airport facility 50 comprises at least one parking zone 52, at least one takeoff and landing runway 54 and at least one taxiway 56 connecting the parking zone 52 and the takeoff and landing runway 54.

Prior to takeoff, the aircraft 10 follows a first trajectory 58 on a first taxiway 56 going from the parking zone 52 to the takeoff and landing runway 54. After it lands, the aircraft 10 follows a second trajectory 58′ on a second taxiway 56′ connecting the takeoff and landing runway 54 and the parking zone 54. The airport facility 50 may comprise a single taxiway 56 and the aircraft may follow a single trajectory 58 between the parking zone 52 and the takeoff and landing runway 54.

The airport facility 50 comprises at least one energy emitting system 60 comprising at least one energy emitting element 32 and at least one electric power supply 62 configured to supply the energy emitting element 32 with electrical energy.

According to embodiments visible in FIGS. 3 and 4, the energy emitting system 60 comprises a single continuous energy emitting element 32 that extends along the trajectory 58.

In the case of an electrical energy transfer device of contactless type visible in FIG. 3, the energy emitting element 32 is in the form of an electromagnetic element 64, such as at least one coil, which extends along the trajectory 58.

In the case of an electrical energy transfer device of contact-based type visible in FIG. 4, the energy emitting element 32 is in the form of a rail 66 or a conductive cable that extends along the trajectory 58.

According to a first configuration, the energy emitting element 32 is static and positioned protruding with respect to the ground S or flush with the ground S.

According to another configuration, the energy emitting element 32 is able to move between a retracted position in which the energy emitting element 32 is positioned below or level with the ground S and a deployed position in which the energy emitting element 32 is positioned protruding with respect to the ground S or level with the ground S. In this case, the energy receiving element 28 may be fixed with respect to the landing gear 16, 18.

According to another embodiment, the airport facility 50 comprises a land vehicle supporting the energy emitting element 32 and integrating the electric power supply 62. According to this configuration, the aircraft 10 and the land vehicle follow one another along the trajectory 58 when the aircraft 10 is moving between the parking zone 52 and the takeoff and landing runway 54.

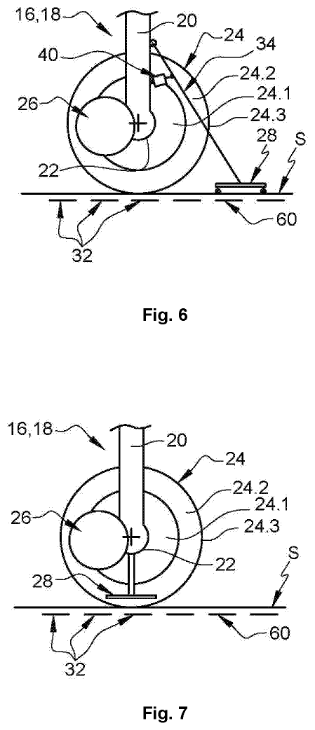

According to another embodiment, visible in FIGS. 6 to 9, the energy emitting system 60 comprises a plurality of energy emitting elements 32 spaced apart from one another and distributed along the trajectory 58. According to this embodiment, each energy emitting element 32 is in the form of a plate comprising at least one coil.

According to a first configuration, each energy emitting element 32 is static. According to another configuration, each energy emitting element 32 is able to move between a deployed position in which it cooperates with the energy receiving element 28 and a retracted position in which it does not cooperate with the energy receiving element 28.

The fact that an aircraft is equipped with at least one energy receiving element 28 and an electric drive system 26 powered by the energy receiving element 28 and configured to move the aircraft on the ground S, and that an airport facility 50 is equipped with an energy emitting element 32 configured to form, with the energy receiving element 28 of the aircraft 10, an electrical energy transfer device, makes it possible to reduce the on-board mass and the fuel consumption of the aircraft since the latter no longer consumes fuel in order to move on the ground. This also makes it possible to reduce the noise and CO₂ emissions at the airport facility 50.

According to one configuration, the airport facility 50 comprises an automatic guidance system for the aircraft taxiing on the taxiways 56. According to this configuration, the receiving and emitting elements 28 and 32 may perform a wire guidance function.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority

Claimed is:

1. An aircraft comprising:
at least one landing gear having at least one wheel configured to roll on the ground when the aircraft is moving on the ground;
at least one electric drive system configured to drive the wheel in rotation; and
at least one energy receiving element configured to power the at least one electric drive system and cooperate with an energy emitting element present on the ground, the at least one energy receiving element and the energy emitting element forming an electrical energy transfer device configured to allow, when the aircraft is moving on the ground, a transfer of electrical energy from the energy emitting element to the at least one energy receiving element,
wherein the at least one energy receiving element comprises at least one caster configured to roll on the ground and keep the at least one energy receiving element at a given distance from the ground.

2. The aircraft according to claim 1, wherein the at least one energy receiving element is an electromagnetic induction element configured to generate an electric current when the electromagnetic induction element is positioned in a magnetic field generated by the energy emitting element.

3. The aircraft according to claim 1, wherein the at least one energy receiving element is separate from the wheel.

4. The aircraft according to claim 1, further comprising:
at least one deployment system configured to move the at least one energy receiving element between a deployed position in which the at least one energy receiving element cooperates with the energy emitting element and a retracted position in which the at least one energy receiving element does not generate aerodynamic disturbances when the aircraft is in flight.

5. The aircraft according to claim 4, wherein the at least one deployment system has a pylon having a first end connected by an articulation to a part of the aircraft that is configured to move between deployed and retracted positions and a second end connected to the at least one energy receiving element and at least one actuator configured to move the at least one energy receiving element between first and second positions.

6. Aircraft according to claim 4, wherein the at least one energy receiving element is fixed with respect to a mobile part of the aircraft that is configured to move between deployed and retracted positions.

7. The aircraft according to claim 1, wherein the at least one electric drive system is positioned at the at least one landing gear and separate from the wheel and in that the at least one landing gear comprises a coupling system connecting the wheel and the at least one electric drive system.

8. The aircraft according to claim 1, wherein the at least one electric drive system is integrated in the wheel as a wheel motor.
